(19) United States
(12) Patent Application Publication
(10) Pub. No.: US 2026/0336224 A1
(43) Pub. Date: Oct. 29, 2026

(54) CONTROLLING A TESSELLATED PRINT BED FOR A THREE-DIMENSIONAL PRINTER

(71) Applicant: INTERNATIONAL BUSINESS MACHINES CORPORATION, ARMONK, NY (US)

(72) Inventors: Elizabeth Jane Maple, Basingstoke (GB); Daniel Thomas Cunnington, Boulder, CO (US); Jonah Benjamin Michael Luckett, Derby (GB); Gwilym Benjamin Lee Newton, Winchester (GB)

(21) Appl. No.: 19/235,345

(22) Filed: Jun. 11, 2025

(30) Foreign Application Priority Data
Apr. 23, 2025 (GB) 2506023.7

(51) Int. Cl. B29C 64/393; B29C 64/295; B33Y 10/00; B33Y 30/00; B33Y 50/02

(52) U.S. Cl. CPC B29C 64/393; B29C 64/295; B33Y 10/00; B33Y 30/00; B33Y 50/02

(57) ABSTRACT

A method, system, and computer program product for controlling a print bed for a three-dimensional printer, the print bed comprising individually activatable tessellated heating elements. The method may include reading commands for a first layer of a print object to determine data points of a polygon of contact of the print object with the print bed. The method may further include determining an overlap of the polygon of contact with the individually activatable tessellated heating elements. The method may also include selecting, based on the determining, heating elements from the individually activatable tessellated heating elements that are overlapped by the polygon of contact and sending a command to activate the selected heating elements.

### BACKGROUND

The present disclosure relates to three-dimensional (3D) printing and, more specifically, to controlling a tessellated print bed for a three-dimensional printer.

3D printing is a fabrication technology which involves the creation of an object by depositing material in a layer-by-layer manner on a print bed or on a build plate. 3D printers use a process of computer-aided design and additive manufacture to create objects layer by layer. One type of material extrusion technique is fused deposition modelling (FDM), also known as fused filament fabrication (FFF), where a continuous filament of a thermoplastic or a metal material is deposited onto the print bed.

### SUMMARY

Various embodiments are directed to a method of controlling a print bed for a three-dimensional (3D) printer, wherein the print bed includes individually activatable tessellated heating elements. The method can include reading commands for a first layer of a print object to determine data points of a polygon of contact of the print object with the print bed and determining an overlap of the polygon of contact with the individually activatable tessellated heating elements. The method can also include selecting, based on the determining, heating elements from the individually activatable tessellated heating elements that are overlapped by the polygon of contact and sending a command to activate the selected heating elements.

Further embodiments are directed to a system for a three-dimensional (3D) printer. The system can include a print bed having tessellated heating elements, wherein each of the tessellated heating elements can include an individually heatable wire configured to heat a surface area of the heating element and a switch configured to activate the heatable wire. The system can also include a print bed controller configured to selectively activate the tessellated heating elements. The selectively activating can include activating a minimum number of the tessellated heating elements for a footprint of a print object.

Additional embodiments are directed to a computer program product, the computer program product including a computer readable storage medium having program instructions embodied therewith, the program instructions executable by a processor to cause a device to perform the method.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of typical embodiments and do not limit the disclosure.

FIG. 1 is a flow diagram illustrating an example computer-implemented process of controlling a tessellated print bed for a three-dimensional printer, according to some embodiments.

FIG. 2A is a schematic diagram illustrating an example print bed system including a tessellated print bed and a print bed controller, according to some embodiments.

FIG. 2B is a schematic diagram illustrating an example pattern of heating wire in each heating element, according to some embodiments.

FIG. 2C is a schematic diagram illustrating a thermal view of the print bed in FIG. 2B, according to some embodiments.

FIG. 2D is a schematic diagram illustrating two examples of configurable print beds, according to some embodiments.

FIG. 3A illustrates a 3D representation of a print space that may be displayed by a slicer software, according to some embodiments.

FIG. 3B illustrates a thermal view of the 3D representation in FIG. 3A, according to some embodiments.

FIG. 4 is a flow diagram illustrating an example process for controlling a tessellated print bed for a 3D printer, according to some embodiments.

FIG. 5 is an operation diagram illustrating an example of a 3D printing system in which the print bed controller illustrated in FIG. 2A may be implemented, according to some embodiments.

FIG. 6 illustrates a computing environment, according to some embodiments.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

Aspects of the present disclosure relate generally to three-dimensional (3D) printing and, more specifically, to controlling a tessellated print bed for a three-dimensional printer. While the present disclosure is not necessarily limited to such applications, various aspects of the disclosure may be appreciated through a discussion of various examples using this context.

3D printing is a fabrication technology that involves the creation of an object by depositing material in a layer-by-layer manner on a print bed or on a build plate. One type of material extrusion technique is fused deposition modelling (FDM), also known as fused filament fabrication (FFF), where a continuous filament of a thermoplastic or a metal material is deposited onto the print bed. 3D printers use a process of computer-aided design and additive manufacture to create objects layer by layer. Material can be added continuously until an object is complete. 3D modeling software allows for precision designs to create a model. The model is then sliced into layers in order for the printer to create the object. Slicing software takes a scan of each layer of the model and instructs the printer how to move in order to recreate the layer. The printer has a nozzle that moves across a 3D print zone, dispensing a modeling material that dries sufficiently to allow the next layer to be added.

A 3D printer has a print bed in the form of a build surface on which the layers of the modeling material are disposed. Heated print beds that provide various benefits can be used. For example, bed adhesion can be improved with a heated print bed as the heated surface prevents the extruded material from cooling too quickly. A heated print bed can also prevent internal stresses between layers as the material cools. A heated print bed can also help prints to detach cleanly from the print bed by cooling in a controlled manner.

One of the largest consumers of power in a 3D printer is the element required to heat the print bed. Traditionally, this element heats the entire bed, regardless of the footprint of the object being printed. For example, it has been estimated that 0.6 W of power is needed for every square centimeter of heated bed area to reach a standard bed temperature for acrylonitrile butadiene styrene (ABS) prints (about 120 °C).

It is also noted that the most common cause of 3D printer fires is heat from the print bed. By reducing the power consumed by the heated print bed, this risk can be directly reduced.

Embodiments of a method, system, and computer program product are provided for controlling a tessellated print bed for a 3D printer. The term tessellated is defined as being a pattern of repeated shapes (specifically, polygons) that fit together closely. The print bed can have a plurality of individually activatable tessellated heating elements that are selectively activated to heat a minimum number of the heating elements for a first layer of a print object. This can divide the print bed such that only the heating elements in areas of the bed underneath a print object are heated.

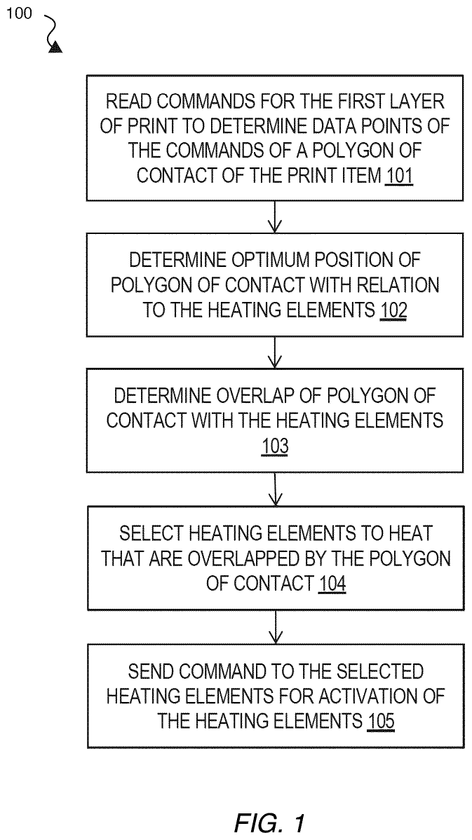

Referring now to the figures, FIG. 1 is a flow diagram illustrating an example computer-implemented process 100 of controlling a tessellated print bed for a three-dimensional printer, according to some embodiments. The print bed is a surface on which objects can be printed. The print bed can be flat and immobile in some embodiments. However, in other embodiments, the print bed or portions of the print bed are moveable.

Slicer software can be used to convert user-designed 3D models into print code instructions. The print code instructions may be in a 3D printing programming language such as geometric code (G-code) machine-level instructions (“G-code instructions”). For example, G-code instructions may instruct the movement of a print head to a location on the print bed and may instruct the amount of material to extrude at that location. At least some of the disclosed techniques may be carried out by the slicer software in association with 3D printer firmware. A 3D model may be input into the slicer software with the slicer software modified to output additional print code instructions.

In process 100, commands can be read from a stream of print code instructions for a first layer of a print object to determine data points of the commands for a polygon of contact of a print object with the print bed. This is illustrated at operation 101. The print object may be an entire item or one or more sections of an item that are printed simultaneously or sequentially on the print bed. The first layer is defined by a parameter referred to as “layer height” in the slicing software.

The print code instructions may be in a 3D printing programming language such as G-code instructions. The polygon of contact may be the footprint of the print object. The footprint is referred to as a polygon as it is made up of multiple edges that may be sufficiently small to form curves of the footprint. The polygon of contact of the print object may define one or more discrete areas of the footprint.

An optimum position of the polygon of contact with relation to the tessellated heating elements can be determined such that a minimum number of heating elements are overlapped by the polygon of contact. This is illustrated at operation 102. The positioning may be automated to adjust the position of the polygon of contact so that it overlaps a minimum number of heating elements of the print bed. Alternatively, the polygon of contact may be displayed to a user in relation to a representation of the tessellated heating elements of the print bed. In response, a user input to move the print object and position the polygon of contact in relation to the representation to manually optimize a position of the print object may be received. The slicing software may be used to position the print object optimally over a set of heating elements to maximize the conditions for bed adhesion for the print object while simultaneously heating the minimum number of heating elements necessary, thus minimizing energy consumption.

In embodiments where multiple sections of a print item are simultaneously printed on the print bed, the positions of polygons of contact of each section may be optimized in relation to one another.

An overlap of the polygon of contact of the print object with the heating elements in the position determined at operation 102 can be determined. This is illustrated at operation 103. The heating elements that are overlapped by the polygon of contact can be selected to be heated. This is illustrated at operation 104.

At the time of printing, a command can be sent to the heating elements selected at operation 104 for activation of the selected heating elements. This is illustrated at operation 105. The heating elements can be configured to be individually addressable by row and column in the tessellation of the print bed. The heating elements may remain activated until deactivated by commands based on the print instruction requirements.

Process 100 may reduce the energy wasted by heating an entire bed for a relatively small contact area between a print object and print bed. Having fewer active heating elements can also reduce the risk of a fire should a thermistor fail, as the area of the print bed that has the potential to overheat is smaller.

A 3D printer can have knowledge of an available print area of the print bed by way of the firmware applied to the 3D printer. There can be several different types of firmware available for a 3D printer, often with configurable parameters such as bed size to achieve an absolute maximum print area available to the user.

Additional firmware data may be included in the firmware, which can detail the coordinates of each heating element of the print bed. The additional firmware data from the print bed may be used by the slicer software to understand the way the bed can be heated. Thus, the user or slicer software itself can more optimally position prints to cover those areas. For example, if there is a print object that is currently positioned over the intersection of four heating elements of the print bed, this may be visualized in the slicer software, and the object may be more optimally positioned so that it covers fewer heating elements of the print bed. This may save energy lost in the form of heat without compromising print quality.

Additional firmware instructions may enable the printer to read in the G-code for the print and decide which heating elements of the print bed the heating commands (codes M140/M190 in G-code) apply to, and heat those accordingly.

The ability to control the heating of targeted areas of the print bed without any external manipulation of G-code may advantageously enable a replacement or additional print bed with the described tessellated heating elements to be added to an existing printer, allowing the existing printer to benefit from the reduced heating requirements.

As an example, a print bed of 10 cm×10 cm may use 60W of power to heat the entire bed (0.6W per cm²). If an object to print has a footprint that overlaps heating elements corresponding to only 2 cm×2 cm of the print bed, the power requirement for heating the object would only be 2.4 W. Therefore, heating the entire print bed to print the object may waste 96% of the supplied power.

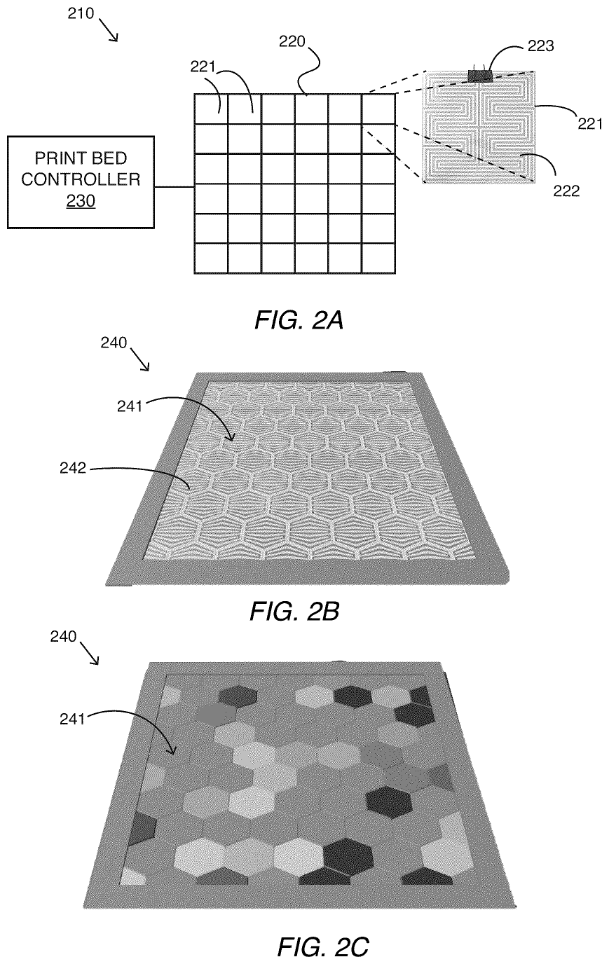

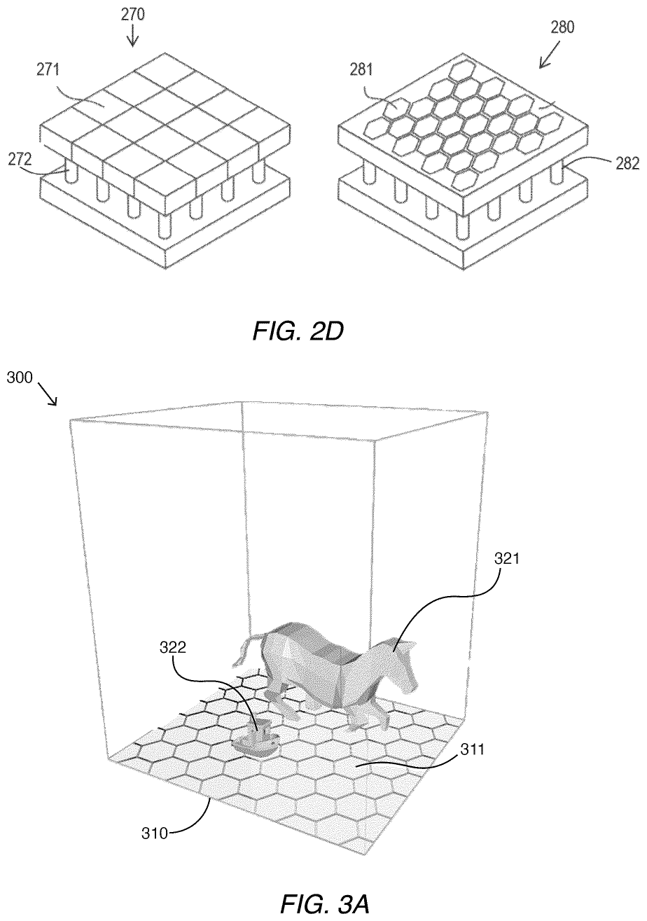

FIGS. 2A-2D are schematic diagrams illustrating examples of tessellated print bed systems, according to some embodiments.

FIG. 2A shows an example print bed system 210 including a tessellated print bed 220 and a print bed controller 230. The print bed 220 includes a plurality of tessellated heating elements 221, each tessellated heating element 221 having a surface area. Each heating element 221 includes an individually heatable wire 222 disposed in an arrangement to heat the surface area of the heating element 221 and a switch 223 to activate the heatable wire.

The tessellated heating elements 221 of print bed 220 are tessellated squares. The heatable wire 222 of each heating element 221 may be formed in pattern of the wire such that it covers the surface area evenly. For example, the pattern may be in the form of square coils. The heatable wires 222 may be made of materials including, but not limited to, nickel-chromium or nickel-chromium-iron alloys (Ni—Cr(Fe)), e.g., nichrome or Chromel® (Concept Alloys, Inc.), etc.; iron-chromium-aluminum alloys (Fe—Cr—Al), e.g., Kanthal® (Kanthal, AB); and copper-nickel alloys (Cu—Ni). The heatable wires 222 may be embedded in a suitable material such as glass, polypropylene, ceramic, etc.

The print bed controller 230 can selectively activate and deactivate a switch 223 of each of the tessellated heating elements 221. The print bed controller 230 can be configured to selectively activate a minimum number of heating elements 221 for a print footprint. The switches 223 may be simple transistors. For the selective activation of the heating elements 221, each heating element 221 may have two additional pins, resulting in four wires going into each heating element 221. Row Address Strobe (RAS) and Column Address Strobe (CAS) may be used to address the heating elements 221 with instructions to activate or deactivate.

FIGS. 2B and 2C show another example of a tessellated print bed 240, according to some embodiments. The tessellated print bed 240 has tessellated hexagonal heating elements 241 with heating wires 242. FIG. 2B illustrates another example pattern of heating wire 242 in each heating element 241. FIG. 2C illustrates a thermal view of the print bed 240 showing variance in heating represented by grayscale shading of the heating elements 241.

The tessellated print bed 240 includes a wiring style that contains a number of heating elements 241 having tessellated coils. Each heating element 241 is individually addressable, allowing for the heating of individual areas of the print bed 240 without needing to heat the whole print bed 240. The 3D printer has knowledge of the size of its own print bed 240, as well as the positions of each of the heating wires 242 underneath it.

In some embodiments, the print bed may include a configurable print bed for a 3D printer as described in U.S. Pat. No. 11,633,914, the contents of which are incorporated herein by reference. However, various configurable print beds may be used. Examples of configurable print beds can include a bed surface including bed surface portions and linear actuators. Each of the bed surface portions can be supported for independent movement. When each of the bed surface portions is positioned at a reference level, the bed surface portions form different parts of a common plane. Each of the linear actuators can be connected to at least one of the bed surface portions, respectively. The linear actuators can be configured to generate the independent movement of the bed surface portions and to affect positioning of the bed surface portions. The set of actuators can be communicatively connected to move corresponding bed surface portions into proper positions to support an object to be printed.

FIG. 2D shows two examples of configurable print beds 270, 280, according to some embodiments. In the first example, the configurable print bed 270 includes tessellated heating elements 271 in the form of squares that are individually raisable by linear actuators 272. In the second example, the configurable print bed 280 includes tessellated heating elements 281 in the form of hexagons that are individually raisable by linear actuators 282.

Embodiments of the configurable print beds 270, 280 may help achieve improved printing of complex structures, and the configurable print beds 270, 280 may help eliminate the need for printing support structures when a build object includes overhanging features. Such printed support structures are often discarded as not being part of a final printed object, thereby constituting wasted modeling material.

Independent movement of the configurable bed surface portions may correspond to one or more of the tessellated heating elements 271, 281. This may enable better adhesion of the raised printed area with the print bed.

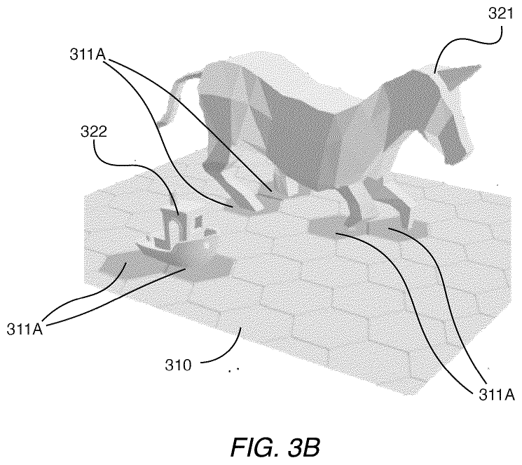

FIG. 3A illustrates a 3D representation 300 of a print space that may be displayed by a slicer software, according to some embodiments. The representation 300 shows a print bed 310 with hexagonal shaped tessellated heating elements 311. A first print object 321 can be printed on the print bed 310. A second print object 322 may be simultaneously or subsequently printed on the print bed 310. The representation 300 may display an automatically optimized position of the print objects 321, 322 in relation to the print bed 310 such that their polygons of contact are in contact with a minimum number of heating elements 311. The representation 300 may be configured to receive user inputs. This can enable a user to position their models of the print objects 321, 322 on the print bed 310 to adjust the contact of the print objects 321, 322 with the heating elements 311. FIG. 3B shows the print objects 321, 322 with a thermal view of the heated heating elements 311A underneath the polygons of contact of the objects 321, 322, according to some embodiments.

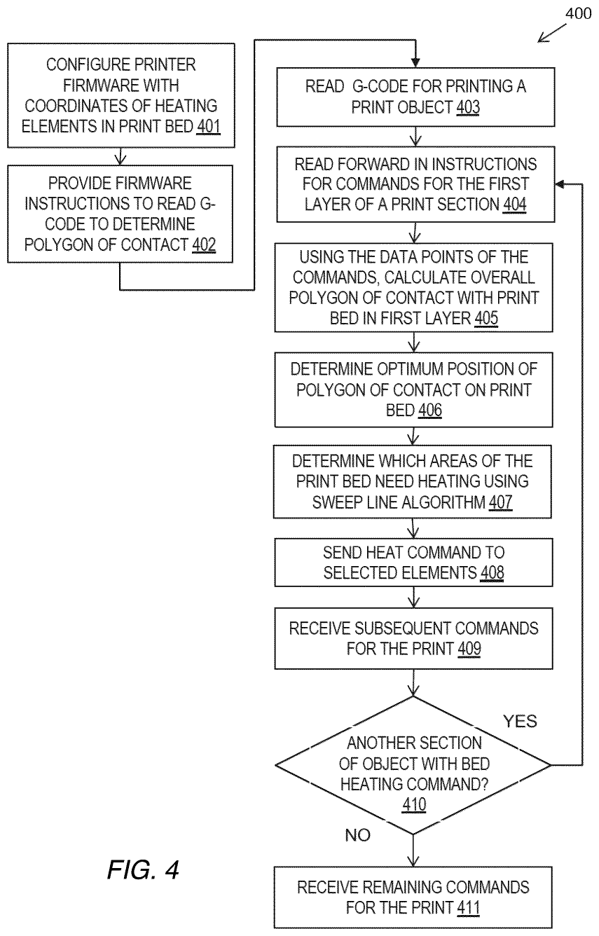

FIG. 4 is a flow diagram illustrating a further example process 400 for controlling a tessellated print bed for a 3D printer, according to some embodiments.

Printer firmware may be configured with coordinates of the tessellated heating elements of the print bed. This is illustrated at operation 401. Firmware instructions may be provided to read G-code to determine polygon of contact for a print object. This is illustrated at operation 402. These steps can enable firmware to be adapted for a tessellated print bed.

The stream of G-code can be sent to the printer firmware. The G-code instructions may be read for printing a print object. This is illustrated at operation 403. The instructions may be read forward in the G-code for heating commands (M140/M190 G-code commands) for a first layer of a print section of the print object. This is illustrated at operation 404. The print section may be the entire print object or a portion of the print object. The first layer can be determined by a parameter called “layer height” and sometimes an override called “first layer height” in the slicing software.

Data points of the heating commands may be used to determine a polygon of contact of the print section with the print bed. This is illustrated at operation 405. The polygon of contact may be formed of multiple discreate polygons. For example, for the horse print object 321 shown in FIG. 3B, there are four discrete polygons in the overall polygon of contact for the print object 321.

The optimum position of the polygon of contact on the print bed may be determined. This is illustrated at operation 406. In some embodiments, this may include optimum relative positioning of polygons of contact for multiple print object sections to be printed simultaneously in a first layer or in subsequent sections that are printed sequentially. However, the optimum position of a polygon of contact for one print object section may be determined in various embodiments.

The tessellated heating elements of the print bed that need to be heated for the print section can be selected. This is illustrated at operation 407. This may include calculating the overlap of a polygon of contact determined at operation 405 in the position determined at operation 406 and the individual heating element coordinates from the printer firmware provided at operation 402. In embodiments in which the tessellated heating elements are hexagons or other polygons, determining which heating elements need to be heated may be achieved using a method such as the sweep line algorithm. The sweep line algorithm provides a way to sort all vertices vertically and consider all the horizontal slices between two vertices. In such a slice, the polygon of contact and the polygons of the heating elements (“heating element polygons”) are seen as a set of trapezoids, and computing the area common to these trapezoids can determine the heating elements to be heated.

Heating commands can be sent to the selected heating elements. This is illustrated at operation 408. The heating commands may be sent using the row and column addressing. In response to the commands, the selected heating elements can be activated. In some embodiments, additional print commands are not sent until the activated heating elements reach a given temperature.

In some embodiments, subsequent G-code instructions may be received. This is illustrated at operation 409. It can be determined based on the subsequent G-code instructions whether there are heating commands for another print section. This is illustrated at operation 410. For example, a subsequent section of the print object may be printed on another area of the print bed. When a print section has finished printing, a command may be sent to the activated heating elements selected at operation 407 for deactivation or reduced heating of these activated heating elements.

If it is determined that there is not a subsequent section of object with bed heating commands (410: NO), remaining print commands may be received with no further heating required. This is illustrated at operation 411.

However, if there is a next print section with heating commands (410: YES), process 400 may loop back to operation 404 to read forward for the first layer of the next print section and may iterate though the subsequent operations in process 400. When determining an optimum position for a polygon of contact for the next print section (operation 406), the position of an already printed section cooling on the print bed may be taken into account. Alternatively, the method may determine positions of the first and next print sections before the first print section is printed (see above) to optimally position all print sections before printing the first section. Continuing the next iteration of process 400, areas of the print bed that need to be heated for the next print section can be selected (operation 407). A command may be sent to the selected heating elements for the next print section for activation of the heating elements (operation 408). Further, commands for the printing of a next section may be received (operation 409), and process 400 may again proceed to operation 410.

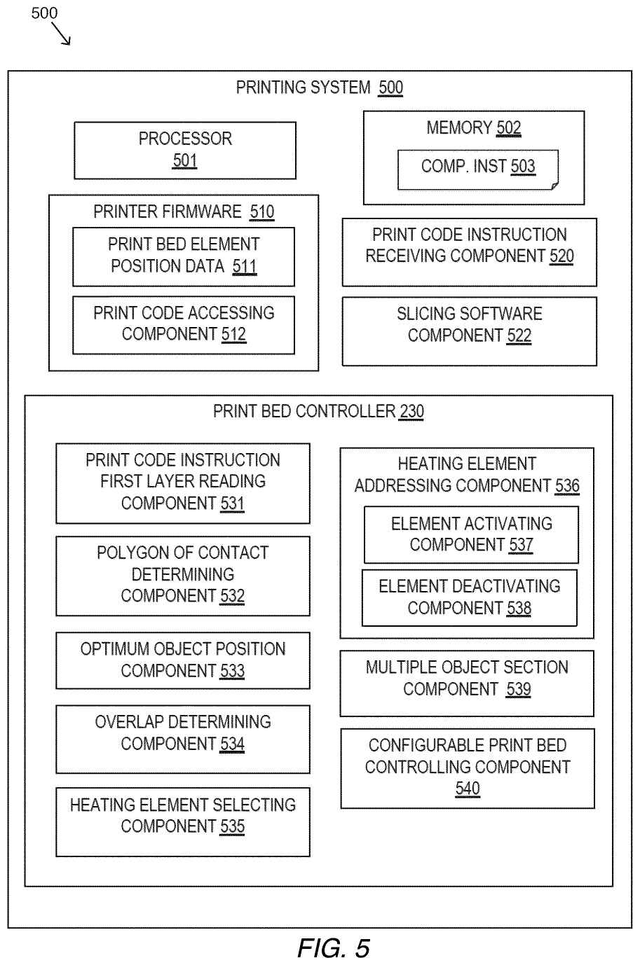

FIG. 5 is an operation diagram illustrating an example of a 3D printing system 500 in which the print bed controller 230 illustrated in FIG. 2A may be implemented, according to some embodiments. As discussed below, the 3D printing system 500 may be used to carry out operations in processes 100 and 400 (FIGS. 1 and 4). The print bed controller 230 may run in association with, or may be incorporated into, slicing software and printer firmware 510 provided in the printing system 500. The printing system 500 may include a slicing software component 522 for accessing the slicing software. The printer firmware 510 may include a print bed element position data component 511 for configuring the print bed tessellated heating element positions. The printer firmware 510 may include a print code instruction accessing component 512 for accessing received print code instructions for a print object. The printing system 500 may include a print code instruction receiving component 520 for receiving print code instructions for a print object.

The printing system 500 may include at least one processor 501 and a hardware module or a circuit for executing the functions of the described components, which may be software units executing on the at least one processor 501. Multiple processors 501 running parallel processing threads may be provided, enabling parallel processing of some or all of the functions of the components. Memory 502 may be configured to provide computer instructions 503 to the at least one processor 501 to carry out the functionality of components of the 3D printing system 500.

The print bed controller 230 may include a print code instruction first layer reading component 531 that can read commands for a first layer of a print object (or print section) to determine data points of the commands of a polygon of contact of the print object with the print bed 220 and a polygon of contact determining component 532 for determining a polygon of contact for the print object from the data points (e.g., at operation 101 or 405).

The print bed controller 230 may include an optimum object position component 533 for determining an optimum position of the polygon of contact with relation to the tessellated heating elements 221 such that a minimum number of the heating elements 221 are overlapped by the polygon of contact (e.g., at operation 102 or 406). The 3D printing system 500 may include a user interface for the slicing software for displaying the polygon of contact in relation to a representation of the tessellated heating elements 221 (e.g., representation 300 shown in FIGS. 3A and 3B) and receiving user input to move the polygon of contact in relation to the representation to optimize a position of the print object on the print bed 220.

The print bed controller 230 may include an overlap determining component 534 for determining an overlap of the polygon of contact with the heating elements 221 (e.g., at operation 103 or 407).

The print bed controller 230 may include a heating element selecting component 535 for selecting the heating elements to heat that are overlapped by the polygon of contact (e.g., at operation 104 or 407).

The print bed controller 230 may include a heating element addressing component 536 including a heating element activating component 537 and a heating element deactivating component 538 for sending commands to the selected heating elements for, respectively, activation (e.g., at operation 105 or 408) and deactivation (e.g., after operation 408, as discussed above with respect to FIG. 4) of the heating elements.

The print bed controller 230 may include a multiple object section component 539 for handling multiple sections of a print object to be printed on the print bed simultaneously.

The print bed controller 230 may include a configurable print bed controlling component 540 for controlling linear actuation for movement of the individual tessellated heating elements in accordance with print code instructions, when a print bed (e.g., print bed 270 or 280 illustrated in FIG. 2D) is configured to linearly actuate independent movement of the tessellated heating elements.

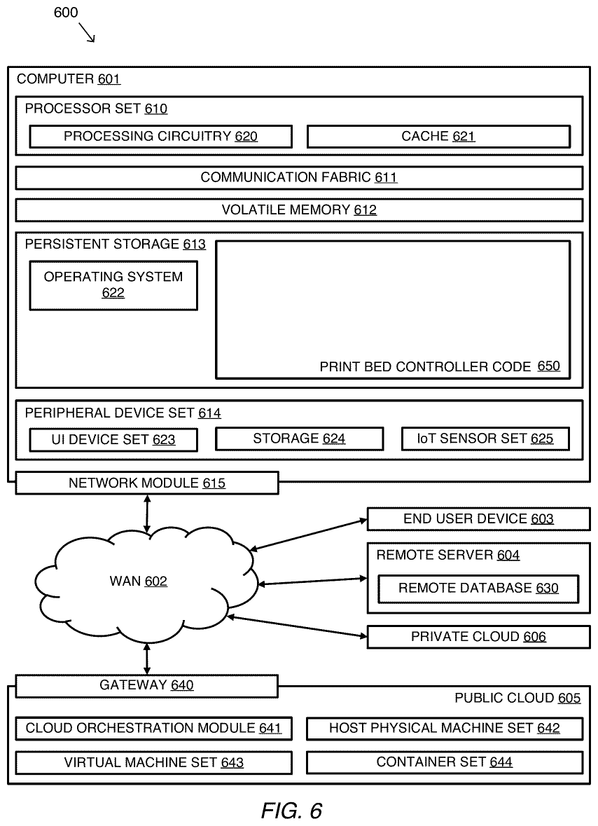

Referring to FIG. 6, computing environment 600 contains an example of an environment for the execution of at least some of the computer code involved in performing the inventive methods, such as print bed controller code 650. In addition to block 650, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 650, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 650 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel. The code included in block 650 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

Although the present invention has been described in reference to specific embodiments, it should be understood that the invention is not limited to these examples only and that many variations of these embodiments may be readily envisioned by the skilled person after having read the present disclosure. The invention may be described without limitation, and by way of example only, by the following embodiments.

Embodiment 1: A computer-implemented method for controlling a tessellated print bed for a three-dimensional printer, the print bed having a plurality of individually activatable tessellated heating elements, comprising: reading commands for a first layer of a print object to determine data points of the commands of a polygon of contact of a print object with the print bed; determining an overlap of the polygon of contact with the heating elements; selecting the heating elements to heat that are overlapped by the polygon of contact; and sending a command to the selected heating elements for activation of the heating elements.

Embodiment 2: The method of embodiment 1, including: determining an optimum position of the polygon of contact with relation to the tessellated heating elements such that a minimum number of heating elements are overlapped by the polygon of contact.

Embodiment 3: The method of embodiment 1 or 2, including: printing multiple print objects on the print bed and determining an optimum position of the polygons of contact of the print objects with relation to the tessellated heating elements such that a minimum number of heating elements are overlapped by the polygons of contact.

Embodiment 4: The method of any one of embodiments 1-3, including: displaying the polygon of contact in relation to a representation of the tessellated heating elements; and receiving user input to move the polygon of contact in relation to the representation to optimize a position of the print object.

Embodiment 5: The method of embodiment 4, wherein displaying the polygon of contact displays the polygon of contact in slicing software.

Embodiment 6: The method of any one of embodiments 1-5, including: configuring coordinates of polygons of the heating elements and calculating the overlap of the polygon of contact and the polygons of heating element coordinates.

Embodiment 7: The method of embodiment 6, wherein calculating the overlap uses a sweep line algorithm including sorting all vertices vertically and considering horizontal slices between two vertices, wherein in such a slice the polygon of contact and the heating element polygon are seen as a set of trapezoids and computing the area common to the trapezoids.

Embodiment 8: The method of any one of embodiments 1-7, wherein the print object is a first section, and the method includes reading commands for a subsequent first layer of a next section including: sending a command to the selected heating elements for the first section for de-activation or a reduced heating of the heating elements; and sending a command to the selected heating elements for the next section for activation of the heating elements.

Embodiment 9: The method of any one of embodiments 1-8, including providing access to print code instructions for a print object to read commands without changing the print code instructions.

Embodiment 10: The method of any one of embodiments 1-9, wherein the print bed is configured to linearly actuate independent movement of the tessellated heating elements, and the method including: controlling the linear actuation for movement of the individual tessellated heating elements in accordance with print code instructions.

Embodiment 11: The method of any one of embodiments 1-10, wherein the method is carried out by or in association with printer firmware and the method includes: configuring printer firmware data with details of the coordinates of each heating element of the print bed; and providing printer firmware instructions to enable the printer firmware to read in print code instructions for a print object and decide which heating elements of the print bed the heating commands.

Embodiment 12: A print bed system for a three-dimensional printer, comprising: a print bed including a plurality of tessellated heating elements with each tessellated heating element having a surface area, wherein each heating element includes an individually heatable wire disposed in an arrangement to heat the surface area of the heating element and a switch to activate the heatable wire; and a print bed controller for selectively activating the switches of each of the tessellated heating elements, wherein the controller is configured to selectively activate a minimum number of heating elements for a print footprint.

Embodiment 13: The system of embodiment 12, wherein the heat bed is configured to be retrofitted to a printer and the print bed controller is configured to receive updated firmware to control the heat bed.

Embodiment 14: The system of embodiment 12 or 13, wherein the print bed is configured to linearly actuate independent movement of the tessellated heating elements.

Embodiment 15: The system of any one of embodiments 12-14, wherein the print bed system includes a processor and a memory configured to provide computer program instructions to the processor to execute a method of the heat bed controller.

Embodiment 16: The system of embodiment 15, wherein the heat bed controller includes: a heating element addressing component in the form of a Row Address Strobe and a Column Address Strobe to address each heating element and tell it to activate or deactivate.

Embodiment 17: The system of embodiment 15 or 16, wherein the heat bed controller includes: a polygon of contact determining component for determining an overlap of a polygon of contact of a print object with the heating elements.

Embodiment 18: The system of any one of embodiments 15-17, wherein the heat bed controller includes: an optimum object position component for determining an optimum position of the polygon of contact with relation to the tessellated heating elements such that a minimum number of heating elements are overlapped by the polygon of contact.

Embodiment 19: The system of any one of embodiments 15-18, wherein the heat bed controller includes: a configurable bed controlling component for controlling a linear actuation for movement of the individual tessellated heating elements in accordance with print code instructions.

Embodiment 20: A computer program stored on a computer readable medium and loadable into the internal memory of a digital computer, the computer program comprising software code portions for performing the method of any of embodiments 1 -11 when said program is run on a computer.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof.

In the previous detailed description of example embodiments of the various embodiments, reference was made to the accompanying drawings (where like numbers represent like elements), which form a part hereof, and in which is shown by way of illustration specific example embodiments in which the various embodiments may be practiced. These embodiments were described in sufficient detail to enable those skilled in the art to practice the embodiments, but other embodiments may be used and logical, mechanical, electrical, and other changes may be made without departing from the scope of the various embodiments. In the previous description, numerous specific details were set forth to provide a thorough understanding the various embodiments. However, the various embodiments may be practiced without these specific details. In other instances, well-known circuits, structures, and techniques have not been shown in detail in order not to obscure embodiments.

When different reference numbers comprise a common number followed by differing letters (e.g., 100a, 100b, 100c) or punctuation followed by differing numbers (e.g., 100-1, 100-2, or 100.1, 100.2), use of the reference character only without the letter or following numbers (e.g., 100) may refer to the group of elements as a whole, any subset of the group, or an example specimen of the group.

As used herein, “a number of” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, and item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; ten of item C; four of item B and seven of item C; or other suitable combinations.

What is claimed is:

1. A method of controlling a print bed for a three-dimensional (3D) printer, wherein the print bed comprises individually activatable tessellated heating elements, and wherein the method comprises:
reading commands for a first layer of a print object to determine data points of a polygon of contact of the print object with the print bed;
determining an overlap of the polygon of contact with the individually activatable tessellated heating elements;
selecting, based on the determining, heating elements from the individually activatable tessellated heating elements that are overlapped by the polygon of contact; and
sending a command to activate the selected heating elements.

2. The method of claim 1, further comprising determining an optimum position for the polygon of contact with relation to the print bed such that the polygon of contact overlaps a minimum number of the individually activatable tessellated heating elements.

3. The method of claim 1, further comprising determining optimum positions for polygons of contact of multiple print objects with relation to the print bed such that the polygons of contact overlap a minimum number of the individually activatable tessellated heating elements.

4. The method of claim 1, further comprising:
displaying the polygon of contact with relation to a representation of the individually activatable tessellated heating elements; and
receiving user input to move the polygon of contact in relation to the representation to optimize a position of the print object.

5. The method of claim 4, wherein the displaying comprises displaying the polygon of contact in slicing software.

6. The method of claim 1, wherein the determining the overlap comprises:
configuring coordinates of heating element polygons for the individually activatable tessellated heating elements; and
calculating an overlap of the polygon of contact and the heating element polygons.

7. The method of claim 6, wherein the calculating comprises, via a sweep line algorithm:
sorting all vertices vertically;
considering a horizontal slice between two of the vertices, wherein the polygon of contact and the heating element polygons are seen as a set of trapezoids; and
computing an area common to the set of trapezoids.

8. The method of claim 1, further comprising:
in response to reading commands for a first layer of a next print object, determining a next polygon of contact with the print bed;
selecting next heating elements from the individually activatable tessellated heating elements overlapped by the next polygon of contact; and
sending commands to activate the selected next heating elements and deactivate or reduce heating of the selected heating elements.

9. The method of claim 1, further comprising providing access to read commands from print code instructions for the print object without changing the print code instructions.

10. The method of claim 1, further comprising controlling linear actuation of the print bed for movement of the individually activatable tessellated heating elements in accordance with print code instructions.

11. The method of claim 1, wherein the method is carried out by or in association with printer firmware and further comprises:
configuring printer firmware data with details of coordinates of each of the individually activatable tessellated heating elements; and
providing printer firmware instructions to enable the printer firmware to read print code instructions for printing the print object and to send commands to the individually activatable tessellated heating elements.

12. A system for a three-dimensional (3D) printer, comprising:
a print bed comprising tessellated heating elements, each of the tessellated heating elements comprising:
an individually heatable wire configured to heat a surface area of the heating element; and
a switch to configured activate the heatable wire; and
a print bed controller configured to selectively activate the tessellated heating elements, wherein the selectively activating comprises activating a minimum number of the tessellated heating elements for a footprint of a print object.

13. The system of claim 12, wherein the print bed is configured to be retrofitted to a printer and the print bed controller is configured to receive updated firmware to control the print bed.

14. The system of claim 12, wherein the print bed is configured to linearly actuate independent movement of the tessellated heating elements.

15. The system of claim 12, further comprising a processor and a memory configured to provide computer program instructions to the processor to perform a method of controlling the print bed controller.

16. The system of claim 15, wherein the print bed controller comprises a heating element addressing component in the form of a Row Address Strobe and a Column Address Strobe, the heating element addressing component configured to instruct the tessellated heating elements to activate or deactivate.

17. The system of claim 15, wherein the print bed controller comprises a polygon of contact determining component configured to determine an overlap of a polygon of contact of the print object with the print bed.

18. The system of claim 15, wherein the print bed controller comprises an optimum object position component configured to determine an optimum position of a polygon of contact of the print object with relation to the tessellated heating elements such that a minimum number of the tessellated heating elements are overlapped by the polygon of contact.

19. The system of claim 15, further comprising a configurable print bed controlling component for controlling linear actuation of the tessellated heating elements in accordance with print code instructions.

20. A computer program product, the computer program product comprising a computer readable storage medium having program instructions embodied therewith, the program instructions executable by a processor to cause a device to perform a method, the method comprising:
controlling a print bed for a three-dimensional printer, the print bed comprising individually activatable tessellated heating elements, wherein the controlling comprises:
reading commands for a first layer of a print object to determine data points of a polygon of contact of the print object with the print bed;
determining an overlap of the polygon of contact with the individually activatable tessellated heating elements;
selecting, based on the determining, heating elements from the individually activatable tessellated heating elements that are overlapped by the polygon of contact; and
sending a command to activate the selected heating elements.
